(19) United States
(12) Patent Application Publication
(10) Pub. No.: US 2022/0134155 A1
(43) Pub. Date: May 5, 2022

(54) A SYSTEM AND METHOD FOR SEMI-AUTONOMOUS ROBOT

(71) Applicant: Jay GADRE, Mumbai (IN)

(72) Inventor: Jay GADRE, Mumbai (IN)

(21) Appl. No.: 17/433,712

(22) PCT Filed: Feb. 25, 2020
(86) PCT No.: PCT/IN2020/050169

§ 371 Date: Aug. 25, 2021

(30) Foreign Application Priority Data
Feb. 25, 2019 (IN) 201821035943

(51) Int. Cl. A62C 27/00; A62C 31/00; A62C 31/02; G05D 1/00; B62D 55/18

(52) U.S. Cl. CPC A62C 27/00; A62C 31/005; B62D 55/18; G05D 1/0038; G05D 1/0022; A62C 31/02

(57) ABSTRACT

In accordance with the present invention, the system comprises a drive assembly, control panel, a power assembly. The power assembly is enclosed by at least one enclosing shield. At least one remote control means, at least one illumination means, and at least one video means disposed in the head portion capable of being oriented. At least one means for cooling the interior and exterior of said system as well as at least one remote control means for directing a flow of fire suppressant onto a fire. Further a method of controlling a fire fighting system is disclosed. Location of a region of interest of a fire is determined. Position and orientation of a nozzle is adjusted in response to location. The adjusting is performed using plurality of motion controller. Further video and audio information of the fire environment at the fire site is communicated to operator/controller through remote wireless means.

### TECHNICAL FIELD

The present invention relates generally to a robot assembly. More particularly the invention relates to a system and method thereof of a robotic system for dynamic monitoring and performance.

### BACKGROUND ART

Generally, the most common tasks involving robotic assembly design relates to the design and mechanism involved for holding equipment in place or to perform a task at stationed place. The advancement of the technology has resulted in to adoption of the same in various domains. One of them is of target-oriented dispensing of fluid materials at desired location. This have found its ways in security and safety domain.

As firefighting subjects rescue personnel to severe risks; both physical and mental. There are numerous risks for firefighting personnel such as intense heat, explosion, falling parts of buildings, sharp objects, and the risk of falling when the range of vision is reduced or is non-existent and mental risks due to extremely stressful situations. The current means to fight fires are for the fireman to enter the burning areas to fight the fires and to perform rescues. This a very dangerous for the firefighter. There also exists a need for a device to pre-install a firefighting device within a premise. Alternatively, some robotic systems are deployed that need external support for the extinguishing agent. However, such systems are dangerous in extreme temperatures.

There exists a need for a system and method thereof to fight a fire at an early stage before it spreads is paramount in the fighting of fires.

For the reasons stated above, at least one of the reasons above, which will become apparent to those skilled in the art upon reading and understanding the specification, there is a need in the art for an assembly which overcomes the drawbacks associated with the prior art.

### SUMMARY

The present invention is a system and method thereof for dynamic monitoring and performance. According to one of the embodiments of the present invention, the system includes but not limited to a drive assembly, the drive assembly comprise of at least one engine/motor and plurality of driving elements driving the motion of the system. The system comprise of control panel to control the operation and movement of the system. The system is by a power assembly, the power assembly may receive power from at least one external source or alternatively the power assembly may be constituted of a plurality of batteries, the plurality of batteries may be rechargeable or of one time use replaceable. The at least one power assembly may be constituted of at least one IC engine. Further, the at least one power assembly may be constituted of a plurality of fuel cells, wherein the plurality of fuel cells includes high temperature fuel cells and low temperature fuel cells. The power assembly is essentially enclosed by at least one enclosing shield protecting said at least one power assembly from all hazards such as but not limited to high temperature, exposure to chemicals in any of the form. The system may further include at least one remote control means for controlling said at least one engine/motor to thereby position the system with respect to a fire, at least one illumination means and at least one video means for displaying at least one image of the area around said system at a remote location, said at least one illumination means and said at least one video means disposed in the head portion are capable of orienting in the desired direction and at least one means for cooling the interior and exterior of said system as well as at least one remote control means for directing a flow of fire suppressant onto a fire. The method of controlling a fire fighting system/robot/vehicle comprise of determining a location of a region of interest of a fire and adjusting a position and orientation of a nozzle responsive to the determining step. The adjusting step is performed using plurality of motion controller. The said adopted method can communicate video and audio information describing the fire environment at the fire site to said controller through remote wireless means from a safe distance to avoid harm to operator/controller from fire hazard being tackled.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

The above and other objects, features and advantages of the present invention will be more clearly understood from the following detailed description taken in conjunction with the accompanying drawings, in which:

FIG. 1 illustrates a system according to an embodiment of the invention;

FIG. 2 illustrates various views of the system according to an embodiment of the invention;

FIG. 3 illustrates tracks and the shock absorbers of the system according to an embodiment of the invention;

FIG. 4 illustrates bypass valves of hydraulically operated transmission system according to an embodiment of the invention.

### DETAILED DESCRIPTION OF THE INVENTION

The embodiments herein provide an assembly and method of robotic system for dynamic monitoring and performance. Further the embodiments may be easily implemented in various robotic systems. The method of the invention may also be implemented as application performed by a standalone assembly.

The invention described herein is explained using specific exemplary details for better understanding. However, the invention disclosed can be worked on by a person skilled in the art without the use of these specific details.

References in the specification to “ one embodiment” or “ an embodiment” means that a particular feature, structure, characteristic, or function described in connection with the embodiment is included in at lest one embodiment of the invention. The appearances of the phrase “in one embodiment” in various places in the specification are not necessarily all referring to the same embodiment.

Hereinafter, the preferred embodiments of the present invention will be described in detail with reference to the accompanying drawings. Reference now should be made to the drawings, in which the same reference numerals are used throughout the different drawings to designate the same or similar components. For clear description of the present invention, known constructions and functions will be omitted.

Parts of the description will be presented in terms of operations performed by the mechanical assembly, using terms such as locking, fixing, holding, and the like, consistent with the manner commonly employed by those skilled in the art to convey the substance of their work to others skilled in the art. As is well understood by those skilled in the art, the components associated with the assembly can take any design form with acceptable change in dimensions that fall with in the scope of the present invention for incorporating similar features as associated and illustrated by referencing to the present invention.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

According to one of the embodiment of the present invention, an assembly/system may comprising of a base frame assembly, a fire extinguishing mechanism disposed on the base frame assembly, the fire extinguishing mechanism comprising of at least one nozzle arm consisting of internal passageway including at least one nozzle, the nozzle arm capable of moving/directing the at least one nozzle towards desired direction through a plurality of shoulder joints and a plurality of elbow joints constituting the nozzle arm and capable of swivelling laterally and tilting vertically. At least one nozzle coupler may be mounted to a nozzle arm member and includes an internal passageway, which defines a discharge outlet. The assembly/system may further comprise a barrel portion, and one or more fire extinguisher storage portions disposed in the barrel portion for storing a fire extinguisher which provides a jet of a fire-fighting agent. The system may be a fire fighting robot.

According to one of the embodiments of the present invention, the assembly /system may include a drive assembly, the drive assembly may comprise of at least one engine/motor and plurality of driving elements driving the motion of the assembly/system. The assembly/system may comprise of control panel to control the operation and movement of the system. The system may be powered by a power assembly, the power assembly may receive power from at least one external source or alternatively the power assembly may be constituted of a plurality of batteries, the plurality of batteries may be rechargeable or of one time use replaceable. The at least one power assembly may be constituted of at least one IC engine. Further, the at least one power assembly may be constituted of a plurality of fuel cells, wherein the plurality of fuel cells includes high temperature fuel cells and low temperature fuel cells. The power assembly may be essentially enclosed by at least one enclosing shield protecting said at least one power assembly from all hazards such as but not limited to high temperature, exposure to chemicals in any of the form. The assembly /system may further include at least one remote control means for controlling said at least one engine/motor to thereby position the system with respect to a fire, at least one illumination means and at least one video means for displaying at least one image of the area around said system at a remote location, said at least one illumination means and said at least one video means disposed in the head portion may be capable of orienting in the desired direction and at least one means for cooling the interior and exterior of said system as well as at least one remote control means for directing a flow of fire suppressant onto a fire.

According to one another embodiment of the present invention, the provision of the fire extinguisher storage portion may allow for storing a commercially available fire extinguisher, thereby supplying a jet of the fire-fighting agent from the jet outlet to fight a fire.

According to one another embodiment of the present invention, the mounting of a fire extinguisher for supplying a jet of the fire-fighting agent makes it possible to fight a fire at any location such as a location where no external fire extinguishing agent supply system is available.

According to one another embodiment of the present invention, the head portion can be swivelled laterally and tilted vertically, thereby orienting the jet outlet in any direction and allowing a jet of the fire-fighting agent to be directed in any direction. It is thus possible to fight a fire source at any location.

According to a first aspect, a method of controlling a fire fighting system/vehicle/robot may comprise of determining a location of a region of interest of a fire and adjusting a position and orientation of a nozzle responsive to the determining step. The adjusting step is performed using plurality of motion controller. The said adopted method can communicate video and audio information describing the fire environment at the fire site to said controller through remote wireless means from a safe distance to avoid harm to operator/controller from fire hazard being tackled.

According to one of the embodiments of the present invention the system may comprise of platform having thermal insulation structure with a cooling system; a plurality of motors mounted to the platform; a plurality of gears driven by the plurality of motors; a plurality of tracks with an adaptable track shape driven by the plurality of gears; a plurality of track covers that cover the plurality of tracks and the plurality of gears; a driving camera mounted to the platform; a computing means programmed for the system to analyse and fight fires; a remote control device adapted for controlling the computing means; a power source; a cooling agent tank; a cooling agent sprinkler unit connected to the cooling agent tank and adapted for spraying cooling agent on the system / platform to lower the temperature of the system/platform; an extinguishing system platform; an extinguishing system comprising: a plurality of extinguishing agent container attached to the extinguishing system platform; a fire extinguishing nozzle connected to the plurality of extinguishing agent containers; and a nozzle open/close operation unit for operating the fire extinguishing nozzle.

According to one of the embodiments of the present invention the system may comprise of hydraulically operated transmission system. The system may be remotely controlled by RF. The system may be equipped with video and thermographic cameras transmitting live image, which are focused for better view by motors and enable operation in smoke filled/toxic fume environment where a fireman/controller cannot analyse using natural means.

The system may be equipped with suppressant chemical monitor mounted on robot which may be rotated towards the fire using motors

According to one another embodiment of the present invention, when the location of a fire source such as a small fire is detected during movement of the system, the system can access the location of the fire and then supply a jet of a fire-fighting agent to extinguish the fire. The fire-fighting is thus quickly performed at an early stage, thereby making it possible to prevent the spread of the fire.

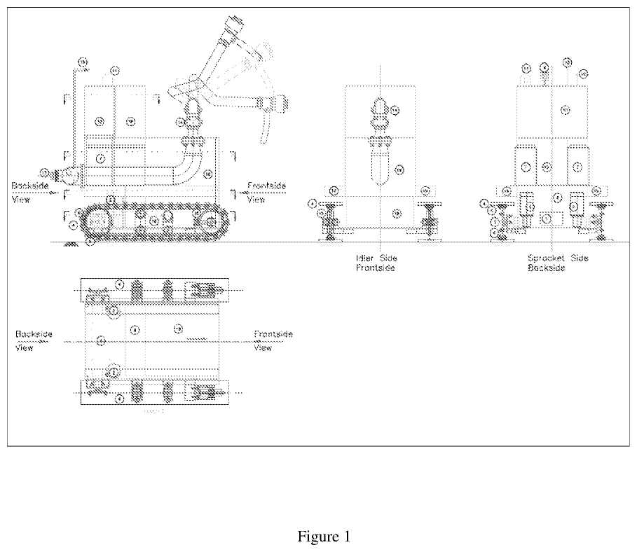

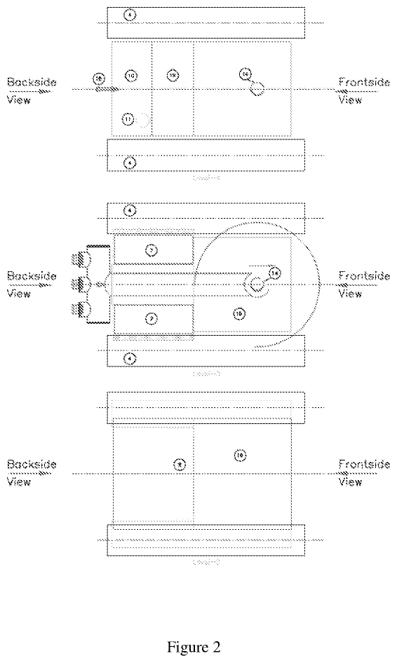

In an implementation of the present invention a system of semi-autonomous robot as shown in fig.1 and 2 comprises a base frame assembly. The base assembly is a installation, holding and mounting platform for all the sub-assemblies, modules, platforms and sub-systems, components, equipment and mechanisms. The base frame assembly have at least one fire extinguishing mechanism disposed on it. The system also has at least one barrel portion. The at least one barrel portion have a plurality of fire extinguisher storage portions disposed in it for storing at least one fire extinguisher which provides at least one jet of at least one of the fire-fighting agents. The system has at least one drive assembly to attend the motion of the system and manoeuvre through the terrain swiftly and sturdily. The system has at least one control panel to control the operation and movement of the system and also have at least one remote control means for controlling said at least one engine/motor of said drive assembly to thereby position the system appropriately as required for example may be with respect to a fire; . The system is equipped with at least one power assembly. To control, drive and position the system appropriately, the system have at least one illumination means, the illumination means such as fog lamp/floodlights, monitors and sensors providing feedback and information signals such as but not limited to water/foam monitor, temperature monitor, sprinkler monitor/cooling system monitor, thermal sensors, thermal imaging sensors etc. and at least one video means for displaying at least one image of the area around said system at a remote location. The system have at least thermal insulation means such as thermal insulation structure of thermal insulation material, the structure providing shield to the system from high thermal exposure and high thermal effect, may be by covering the system fully or partially or isolating the system fully or partially from high thermal exposure. The system have at least one means for cooling the interior and exterior of it, such as but not limited to various cooling systems, one of them may be a sprinkler based cooling system. The system have at least one remote control module, the module is a processor configured to communicate wirelessly over various communication frequencies and protocols and preferably communicating through RF to receive information and videos from the system at remote place, process the information and provide appropriate control signals for positioning the system and for directing a flow of fire suppressant onto a fire.

In an implementation of the present invention a system of semi-autonomous robot comprises at least one platform having thermal insulation structure with a cooling system mounted on the base assembly. The cooling system is made up of and includes but not limited to at least one cooling agent tank to house at least on cooling agent, at least one cooling agent sprinkler unit connected to the at least one cooling agent tank. The cooling system through its cooling agent sprinklers is adapted for spraying at least one cooling agent on the system/platform to lower the temperature of the system/platform.

In an implementation of the present invention a system of semi-autonomous robot comprises at least one drive assembly constituted of but not limited to a plurality of motors mounted to the platform, a plurality of gears driven by the plurality of motors, a plurality of tracks with an adaptable track shape driven by the plurality of gears, a plurality of track covers that cover the plurality of tracks and the plurality of gears. The system has at least one driving camera mounted to the platform. The system has at least one processor configured and programmed for the system to analyse and fight fires and at least one remote control device adapted for controlling and communicating to the at least one processor. The system is powered through at least one power source.

In an implementation of the present invention a system of semi-autonomous robot comprises an extinguishing system platform, said extinguishing system platform includes but not limited to a plurality of extinguishing agent container attached to the extinguishing system platform. The extinguishing system platform have at least one fire extinguishing mechanism connected to the plurality of extinguishing agent containers. It has at least one nozzle operation unit for operating nozzle arm and open/close operation of the fire extinguishing nozzle.

In an implementation of the present invention a system of semi-autonomous robot comprises at least one fire extinguishing mechanism, said at least one fire extinguishing mechanism includes but not limited to at least one nozzle arm, the nozzle arm having at least one internal passageway including at least one nozzle, a plurality of shoulder joints constituting the nozzle arm, a plurality of elbow joints constituting the nozzle arm, and at least one nozzle coupler mounted to a nozzle arm member and includes an internal passageway, which defines a discharge outlet. The nozzle arm is capable of moving/directing the at least one nozzle towards desired direction through a plurality of shoulder joints and a plurality of elbow joints constituting the nozzle arm and capable of swivelling laterally and tilting vertically. Further, the head portion of the nozzle arm can be swivelled laterally and tilted vertically, thereby orienting the jet outlet in any direction and allowing a jet of the fire-fighting agent to be directed in any direction.

In an implementation of the present invention the drive assembly is comprise of at least one engine/motor and plurality of driving elements driving the motion of the system. The control panel is configured to control the operation and movement of the system. The at least one power assembly of the system may receive power from at least one external source. The at least one power assembly is constituted of a plurality of batteries, the plurality of batteries may be rechargeable or of one time use replaceable. The at least one power assembly may be constituted of at least one IC engine. Further, the at least one power assembly may be constituted of a plurality of fuel cells, wherein the plurality of fuel cells includes high temperature fuel cells and low temperature fuel cells. The said at least one power assembly is essentially enclosed by at least one enclosing shield protecting said at least one power assembly from all hazards such as but not limited to high temperature, exposure to chemicals in any of the form.

In an implementation of the present invention, the at least one illumination means and the at least one video means are disposed in the head portion and are be capable of orienting in the desired direction. The system includes but not limited to video and thermographic cameras transmitting live image, which are focused for better view by motors and enables operation in smoke filled/toxic fume environment where a fireman /controller cannot analyse using natural means. The system is equipped with suppressant chemical monitor mounted on system/robot which can be rotated towards the fire using motors.

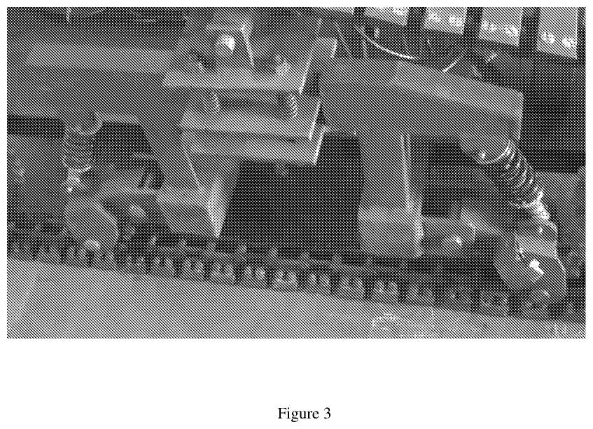

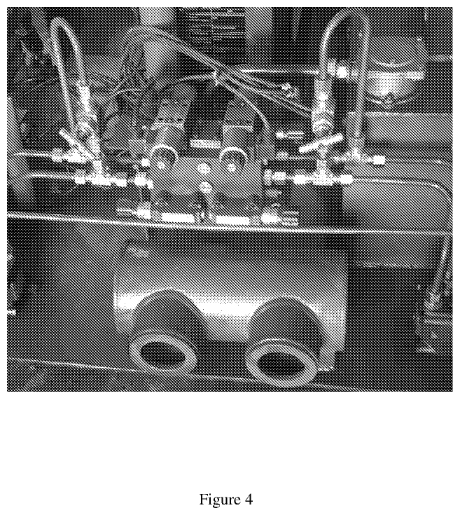

In an implementation of the present invention the system is constituted of at least one transmission system, said transmission system is a hydraulically operated transmission system. The hydraulically operated transmission system includes bypass valves as shown in FIG. 4, which when opened, the system traction/movement can be done with manual intervention as well as fully manually. Further, the system is comprising of tracks for traction and shock absorbers wherein the tracks may be the caterpillar tracks and the shock absorbers are multi spring load, angled spring wheel assembly as shown in FIG. 3.

In an implementation of the present invention the system through drive assembly and control panel is configured to multi terrain and obstacle climbing characteristics that enables deployment of the system and method thereof in difficult zones.

In an implementation of the present invention the system is configured to fight a fire at any location such as a location where no external fire extinguishing agent supply system is available by mounting of a fire extinguisher for supplying a jet of the fire-fighting agent.

A method adopted and performed by the Semi-autonomous Robot comprise steps of determining a location of a region of interest of a fire based on the received information that may include the lat-long coordinate, GPS data, the feedback from the various sensors in the for of feedback signals, information signals, trigger signals , command signals etc. As a next step of the method performed by the Semi-autonomous Robot, it adjusts to at least one position and orientation of at least one nozzle in response to the determining step wherein the step of adjusting a position and orientation of a nozzle is performed using plurality of motion controller. Further, as a next step videos and audios information describing the fire environment at the fire site is communicated to said controller through remote wireless means. The information and signals are received at the remote location through remote wireless means. Further, as a step of execution of extinguishing of fire, the system performs the nozzle arm operation and nozzle operation according to analysis and control signals received at the system form the remote control means at the remote location from a safe distance to avoid harm to operator/controller from fire hazard being tackled, and as a continuing process step throughout the operation of the system during fire extinguishing the cooling system operates to maintain and lower the temperature of the system to its functional and operational safety.

According to the embodiments, the present invention provides a means for and performs remote operation so that fireman/controller is not exposed by/to Fire Hazard like Toxic fumes/burning/falling objects. This may be attended through RF operation. The communication and control/signalling of said system and the method thereof may not be dependent on Internet or Mobile communication so operation in remote areas possible and also useful in Disaster Management when existing infrastructure breaks down. This may be implemented RF operation with independent power source. Fire suppressant chemical use may extinguish fire faster minimizing secondary damage due to excess water use or prevents spread of toxic/flammable burning substance through water spread.

The present invention enhances thermal capability & focus where normal vision of fireman/controller is obstructed due to smoke, glare and toxic fumes. The present invention computes and pinpoint source of fire and identify location of injured/fallen victims. The system of the present invention, being a mechanized object have holding power, and may continuously do fire fighting operation for many hours when a fireman cannot sustain the environment for more than a few minutes. This is due to inherent cooling and control mechanism of the system and the method thereof.

The system of the present invention have multi terrain and obstacle climbing characteristics that enable deployment of the system and method thereof in difficult zones.

I claim:

1. A system of Semi-autonomous Robot, the system comprises
a base frame assembly;
at least one fire extinguishing mechanism disposed on the base frame assembly;
at least one barrel portion;
a plurality of fire extinguisher storage portions disposed in the barrel portion for storing at least one fire extinguisher which provides at least one jet of at least one fire-fighting agent;
at least one drive assembly;
at least one control panel; to control the operation and movement of the system;
at least one power assembly;
at least one remote control means for controlling said at least one engine/motor of said drive assembly to thereby position the system with respect to a fire;
at least one illumination means and at least one video means for displaying at least one image of the area around said system at a remote location;
at least one means for cooling the interior and exterior of said system; and
at least one remote control means for directing a flow of fire suppressant onto a fire.

2. The system of Semi-autonomous Robot as claimed in claim 1, the system further comprises:
a base frame assembly;
at least one platform having thermal insulation structure with a cooling system mounted on base assembly, said cooling system comprises:
a cooling agent tank;
a cooling agent sprinkler unit connected to the cooling agent tank and adapted for spraying at least one cooling agent on the system/platform to lower the temperature of the system/platform;
at least one drive assembly, said drive comprise
a plurality of motors mounted to the platform;
a plurality of gears driven by the plurality of motors;
a plurality of tracks with an adaptable track shape driven by the plurality of gears;
a plurality of track covers that cover the plurality of tracks and the plurality of gears;
at least one driving camera mounted to the platform;
at least one processor configured and programmed for the system to analyse and fight fires;
at least one remote control device adapted for controlling and communicating to the at least one processor;
at least one power source;
an extinguishing system platform, said extinguishing system platform comprising:
a plurality of extinguishing agent container attached to the extinguishing system platform;
a fire extinguishing mechanism connected to the plurality of extinguishing agent containers; and
a nozzle operation unit for operating nozzle arm and open/close operation of the fire extinguishing nozzle.

3. The fire extinguishing mechanism as claimed in claim 2, wherein said fire extinguishing mechanism comprises:
at least one nozzle arm, the nozzle arm comprises:
an internal passageway including at least one nozzle;
a plurality of shoulder joints constituting the nozzle arm;
a plurality of elbow joints constituting the nozzle arm;
at least one nozzle coupler may be mounted to a nozzle arm member and includes an internal passageway, which defines a discharge outlet.

4. The nozzle arm as claimed in claim 2 wherein the nozzle arm is capable of moving/directing the at least one nozzle towards desired direction through a plurality of shoulder joints and a plurality of elbow joints constituting the nozzle arm and capable of swivelling laterally and tilting vertically.

5. The drive assembly as claimed in claim 1 and claim 2 wherein said drive assembly may comprise of at least one engine/motor and plurality of driving elements driving the motion of the system.

6. The control panel as claimed in claiml at is configured to control the operation and movement of the system.

7. The power assembly as claimed in claim 1 receive power from at least one external source.

8. The at least one power assembly as claimed in claim 1 is constituted of a plurality of batteries, the plurality of batteries may be rechargeable or of one time use replaceable.

9. The at least one power assembly as claimed in claim 1 is constituted of at least one IC engine.

10. The at least one power assembly as claimed in claim 1 is constituted of a plurality of fuel cells, wherein the plurality of fuel cells includes high temperature fuel cells and low temperature fuel cells.

11. The at least one power assembly as claimed in claiml, wherein said at least one power assembly is essentially enclosed by at least one enclosing shield protecting said at least one power assembly from all hazards such as but not limited to high temperature, exposure to chemicals in any of the form.

12. The at least one illumination means and the at least one video means as claimed in claim 1 are disposed in the head portion and are be capable of orienting in the desired direction.

13. The system as claimed in claim 1 is configured to fight a fire at any location such as a location where no external fire extinguishing agent supply system is available by mounting of a fire extinguisher for supplying a jet of the fire-fighting agent.

14. The system as claimed in claim 1 wherein the head portion of the nozzle arm can be swivelled laterally and tilted vertically, thereby orienting the jet outlet in any direction and allowing a jet of the fire-fighting agent to be directed in any direction.

15. The system as claimed in claim 1 comprise of hydraulically operated transmission system.

16. The system as claimed in claim 1 wherein the hydraulically operated transmission system includes bypass valves, which when opened, the system traction/movement can be done with manual intervention as well as fully manually.

17. The system as claimed in claim 1 comprise of tracks for traction and shock absorbers wherein the tracks may be the caterpillar tracks and the shock absorbers are multi spring load, angled spring wheel assembly.

18. The system as claimed in claim 1 is remotely controlled by RF.

19. The system as claimed in claim 1, wherein system further comprise of video and thermographic cameras transmitting live image, which are focused for better view by motors and enables operation in smoke filled/toxic fume environment where a fireman /controller cannot analyse using natural means.

20. The system may be equipped with suppressant chemical monitor mounted on robot which may be rotated towards the fire using motors.

21. The system as claimed in claim 1 wherein the system through drive assembly and control panel configured to multi terrain and obstacle climbing characteristics that enables deployment of the system and method thereof in difficult zones.

22. A method of Semi-autonomous Robot, the method comprising steps of
determining a location of a region of interest of a fire;
adjusting a position and orientation of a nozzle responsive to the determining step wherein the step of adjusting a position and orientation of a nozzle is performed using plurality of motion controller;
communicating video and audio information describing the fire environment at the fire site to said controller through remote wireless means;
receiving control signals through remote wireless means;
performing the nozzle arm operation and nozzle operation according to analysis and control signals received at the system form the remote control means at the remote location from a safe distance to avoid harm to operator/controller from fire hazard being tackled; and
operating cooling system to maintain and lower the temperature of the system to its functional and operational safety.
